(19) United States
(12) Patent Application Publication
(10) Pub. No.: US 2005/0091145 A1
(43) Pub. Date: Apr. 28, 2005

(54) Method for managing data regarding derivatives transactions

(75) Inventors: Richard A. Baker, Evanston, IL (US); Brian Laird, Carpentersville, IL (US); Lance Klein, Naperville, IL (US); Matt Sweetnam, Planfield, IL (US); Brent Billows, Chicago, IL (US); Steven Karlovitz, Glendale Heights, IL (US); John Compall, Des Plaines, IL (US); Diane Schuering, Chicago, IL (US); Marc MacQuarrie, Chicago, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: The Clearing Corporation, Chicago, IL (US)

(21) Appl. No.: 10/804,693

(22) Filed: Mar. 19, 2004

Related U.S. Application Data
(60) Provisional application No. 60/457,233, filed on Mar. 25, 2003.

(51) Int. Cl. G06F 17/60

(52) U.S. Cl. 705/37

(57) ABSTRACT

A method for managing data regarding executed derivatives trades is used to support the operations of a derivatives clearinghouse. The method may be implemented with a web server and a database server. The web server receives requests from client computers for information regarding derivatives trades that have been previously cleared by the clearinghouse and, in coordination with the database server, provides the information to the client computers.

### CROSS-REFERENCE TO RELATED APPLICATIONS

This Application claims the benefit of the filing date of U.S. Provisional Application No. 60/457,233, which is entitled METHOD AND SYSTEM FOR CLEARING TRADES and was filed on Mar. 25, 2003.

### FIELD OF THE INVENTION

This invention relates generally to the management of data for previously-executed derivatives trades. More particularly, the invention relates to managing such data in support of the operations of a derivatives clearinghouse.

### BACKGROUND OF THE INVENTION

A derivative is a financial contract written on an underlying asset whose value is derived from the value of this asset or whose value is derived from the value of another asset. Two major types of derivatives are futures (or forwards) and options.

A futures contract, or future, is a contract between a buyer and a seller to buy or sell a specified quantity of a commodity or a financial instrument at an agreed price on a designated future date. The delivery price is fixed at the time the contract is agreed upon. An option, in contrast, is a contract that gives the purchaser the right, but not the obligation, to buy or sell a futures contract, or a specified quantity of a commodity or a financial instrument, at an agreed-upon price.

The act of buying or selling a derivative is referred to as a “trade.” Thus, every derivatives trade involves two parties: a seller, who is selling the derivative, and a buyer. The trading of derivatives frequently occurs on an “exchange,” but may also occur off an exchange in the over-the-counter (“OTC”) markets. A derivatives exchange is a regulated institution that provides a forum for buyers and sellers of derivatives to conduct their trades, while OTC derivatives markets may not be regulated. Examples of derivatives exchanges include Eurex, Eurex US, the Chicago Mercantile Exchange, and the Chicago Board of Trade. Examples of OTC markets include CDXchange and ChemConnect.

The execution of a trade occurs either through an electronic trading system, such as Eurex US's system, or in a trading pit, where the trade is conducted verbally (also referred to as “open outcry”). When a buyer and a seller commit to a price for which a future or option is to be bought or sold, the trade is said to have been “executed.” As used herein, the terms “trade” and “executed trade” shall be interchangeable and shall have the same meaning. When a trade is executed via open outcry, the buyer and the seller each create a record that contains the details of the executed trade. The buyer's record and the seller's record of the trade are sent to an institution known as a “clearinghouse.” The clearinghouse compares the seller's record with the buyer's record. If the two records are consistent with one another, then a “match” is said to have occurred. Alternatively, in a fully electronic system that does not rely on the open outcry process, the exchange or OTC marketplace itself automatically matches the buyer's and seller's records, so that by the time a record of the executed trade is sent to the clearinghouse, the trade is already designated as “matched.”

A clearinghouse typically has “participants,” each of whom is either a derivatives trading firm or an individual trader. Only participants of the clearinghouse are permitted to “clear” transactions through the clearinghouse. If a derivatives trading firm (or an individual trader) is not a participant of the clearinghouse, then it must submit its records of executed trades through a participant in the clearinghouse in order to have the trades cleared. The clearinghouse performs a number of functions, among which may be the function of accepting an executed trade after it has been matched, thereby succeeding to all of the rights of the original parties to the trade, and assuming all of the obligations of the original parties to the trade. A clearinghouse also performs such tasks as: settling the executed trade through its clearing participants; collecting and maintaining margin monies; handling the assignment of collateral; and reporting trade data. Examples of clearinghouses include The Clearing Corporation (formerly known as the Board of Trade Clearing Corporation), the New York Clearing Corporation (NYCC), London Clearing House (LCH), and the Options Clearing Corporation (OCC).

As derivatives markets have become increasingly computerized, the need for more sophisticated ways for clearinghouses to maintain and manage data regarding executed derivatives trades has grown accordingly.

### SUMMARY OF THE INVENTION

A method for reversing the clearance of a derivatives trade that was previously executed between a buyer and a seller is provided. According to an embodiment of the invention, the buyer's record of the executed trade and the seller's record of the executed trade are compared to determine whether certain fields in the buyer's record match equivalent fields in the seller's record. The buyer's and the seller's records may include data that identifies the commodity that was traded, identifies the buyer and the seller, and identifies the price at which the commodity was traded. If the data in the buyer's and seller's records matches, then the transaction is accepted. A record indicating that the executed trade has been accepted is then stored in memory, and subsequently retrieved and displayed on a user interface. In response to a user indicating that the acceptance of the executed trade should be negated, an offsetting transaction record for the buyer and an offsetting transaction record for the seller are generated, in which the buyer's and seller's roles are reversed from what they were in the previously executed trade. The comparing and storing steps are then repeated using the offsetting transaction records for the buyer and seller, thereby negating the acceptance of the previously executed trade.

An embodiment of the invention involves transmitting, to a remote computer, a graphical user interface, such as a web page, which has a plurality of rows and columns, wherein each row represents an executed derivatives trade or offsetting transaction entry that has been previously accepted, and each column represents a piece of information concerning the executed trade or transaction entry.

According to another embodiment of the invention, the buyer and seller represent participants of a clearinghouse, and accepting the executed trade involves assuming obligations of the buyer and seller.

In another embodiment of the invention, all of the gains and losses resulting from trades entered into by both the buyer and seller are tallied at the end of the first trading day, and the bank accounts of the buyer and seller are credited or debited based on the results of the tallying step. At the end of a second trading day, all of the gains and losses for both the buyer and seller are tallied, taking into account any offsetting transaction records created to negate any previously executed trades, and the bank accounts of the buyer and seller are credited or debited based on the results of the tallying step, thereby offsetting the acceptance of any previously executed trades that the buyer and seller select to be negated.

In still another embodiment of the invention, a message is displayed to one of the parties to the previously executed trade on a display screen, wherein the message queries the party regarding whether the party agrees that the trade should not have been accepted. The party then may agree or disagree.

Another embodiment of the invention includes a method for generating a graphical user interface for the entry of previously executed trades. The method involves receiving a log-in comprising the identity of a user, selecting a profile from a plurality of profiles, the profile representing which data entry fields of the plurality are to be populated with default values, what the default values are, and which of a plurality of information fields are to be displayed on the user interface, and generating the graphical user interface in accordance with the profile. The plurality of data entry fields may include an identification of the commodity on which the traded derivative is based, and an identification of a broker who executed the trade. The plurality of information fields may also include a trade execution time field and an order type field. In another embodiment of the invention, the graphical user interface may be displayed in a first frame, and alert message may be displaying to the user in a second frame. In one implementation, the alert message relates to post-trading activity. For example, the alert message may indicate to the user-that all post-trading activity needs to stop.

Still another embodiment of the invention involves receiving a login from a user, and retrieving a plurality of executed trade records from a database. Each executed trade record represents a trade in which a first participant (or one of its customers) was either a buyer or a seller, and each trade record is designated as unmatched. The trade records are then displayed on a graphical user interface in such a way as to increase the likelihood that records that match one another are ordered close together. The user selects, via the graphical user interface, a first record and a second record of the plurality. The first and second records represent opposite sides of the same underlying trade entered into by participants (or one of their customers). In response to the user selection of the first and second records, the contents of the first record are edited so that the contents become identical to the contents of the second record. The edited contents of the first record are then stored in the database. In one implementation, the contents of the first record are received from the first firm, and the database is searched for another record that represents the opposite side of the same underlying trade as the first record. Upon failing to locate another such record, the first record is then designated to be unmatched. However, after the storing step, the first and the second record are matched, and a clearinghouse assumes obligations related to the executed trade.

### BRIEF DESCRIPTION OF THE DRAWINGS

FIG. 1 illustrates an example of a computer system according to an embodiment of the invention;

FIG. 2 illustrates another example of a computer system according to an embodiment of the invention;

FIG. 3 illustrates an example of a home page according to an embodiment of the invention;

FIG. 4 illustrates a login dialog box according to an embodiment of the invention;

FIG. 5 illustrates an example of a setup interface according to an embodiment of the invention;

FIG. 6 illustrates an example of a trade summary interface according to an embodiment of the invention;

FIGS. 7a and 7b illustrate an example of a position transfer interface according to an embodiment of the invention;

FIG. 8 illustrates an example of a user interface that permits a user to request that one record of an executed trade be edited to match another record for the opposite side of the same executed trade; and

FIGS. 9 and 10 illustrate a logical decision tree according to an embodiment of the invention.

### DETAILED DESCRIPTION OF THE INVENTION

An example of a computer system configured according to an embodiment of the invention will now be described. Following the description of the computer system, functions that can be carried out in various embodiments of the invention will be described. These functions will be described in the context of the example computer system and, in some cases, be described as being carried out by specific components of the computer system. It should be understood, however, that the various embodiments of the invention are not tied to any specific piece of computer hardware or any particular architecture.

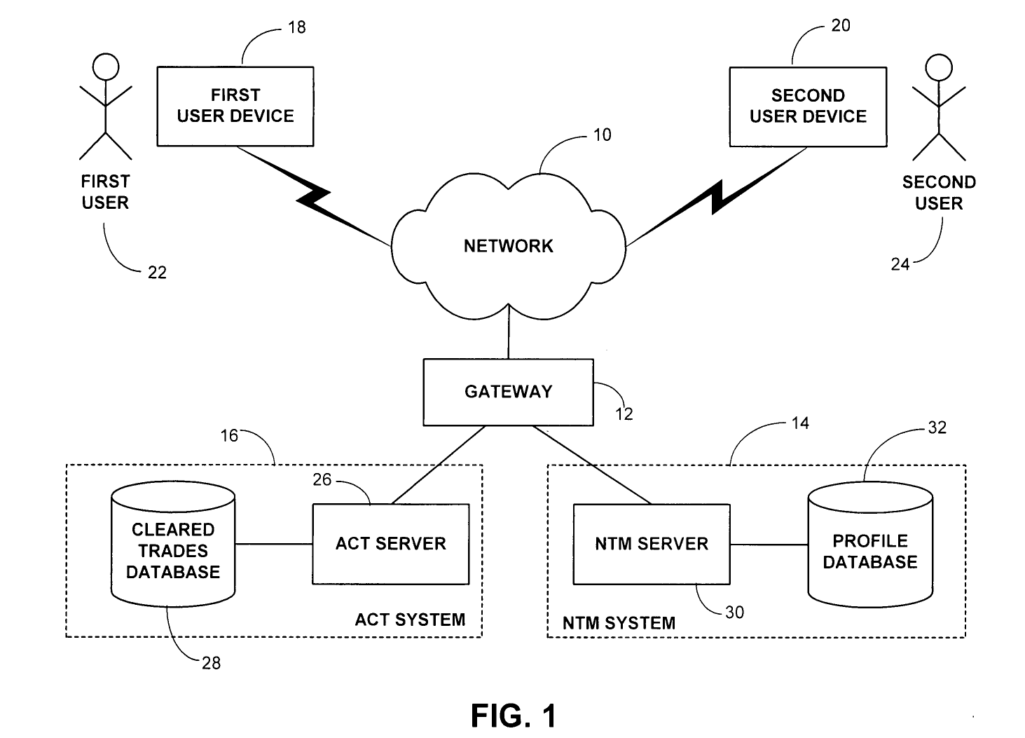

Referring to FIG. 1, the example computer system includes a network 10, a gateway 12, a New Trade Management (NTM™) system 14, and an Allocation and claim Transactions (ACT®) (hereinafter “ACT”) system 16. The network 10 may be implemented in a variety of ways including, but not limited to, a local area network (LAN), a wide area network (WAN), an Extranet, an Intranet, or the Internet. According to one implementation, the network 10 is accessible through the World Wide Web or other public network, which provides a communication path between first and second user devices 18 and 20 and the gateway 12.

The computer system of FIG. 1 can accommodate any number of users. To aid in illustrating the invention, however, FIG. 1 includes two users—a first user 22, operating on the first user device 18, and a second user 24, operating on a second user device 20. Although the first and second users 22 and 24 are depicted as individual people, the term “user” as used herein may include a group of individual users, a trading firm or a financial institution. The first user device 18 and the second user device 20 may be implemented as any type of stationary or mobile computing device, including a personal computer (desktop or laptop), a personal digital assistant (PDA), or a cellular telephone. The gateway 12 communicates with the first and second user devices 18 and 20 via the network 10.

The ACT system 16 includes an ACT server 26 and a database 28 of cleared trades (the “cleared trades database”). The ACT server 26 is communicatively linked to the gateway 12. The NTM system 14 includes an NTM server 30 and a database 32 of user profiles (the “profile database”). The NTM server 30 is also communicatively linked to the gateway 12. The functions of the gateway 12 include providing a front-end interface to users wishing to use the computer system, authenticating those users and routing communication between the first or second user devices and the ACT or NTM systems. Thus, it will be assumed in the following paragraphs that when communication occurs between either the ACT or NTM systems and the first or second user devices, that such communication passes through the gateway 12. The ACT server 26 and the NTM server 30 each provide various services for users of the computer system. These services will be described below in greater detail. It should be understood, however, that the services provided by the ACT and NTM systems may all be performed by a single computer or a single group of computers. The division of these services between an “ACT system” and an “NTM system” as described herein is just one of many possible architectures.

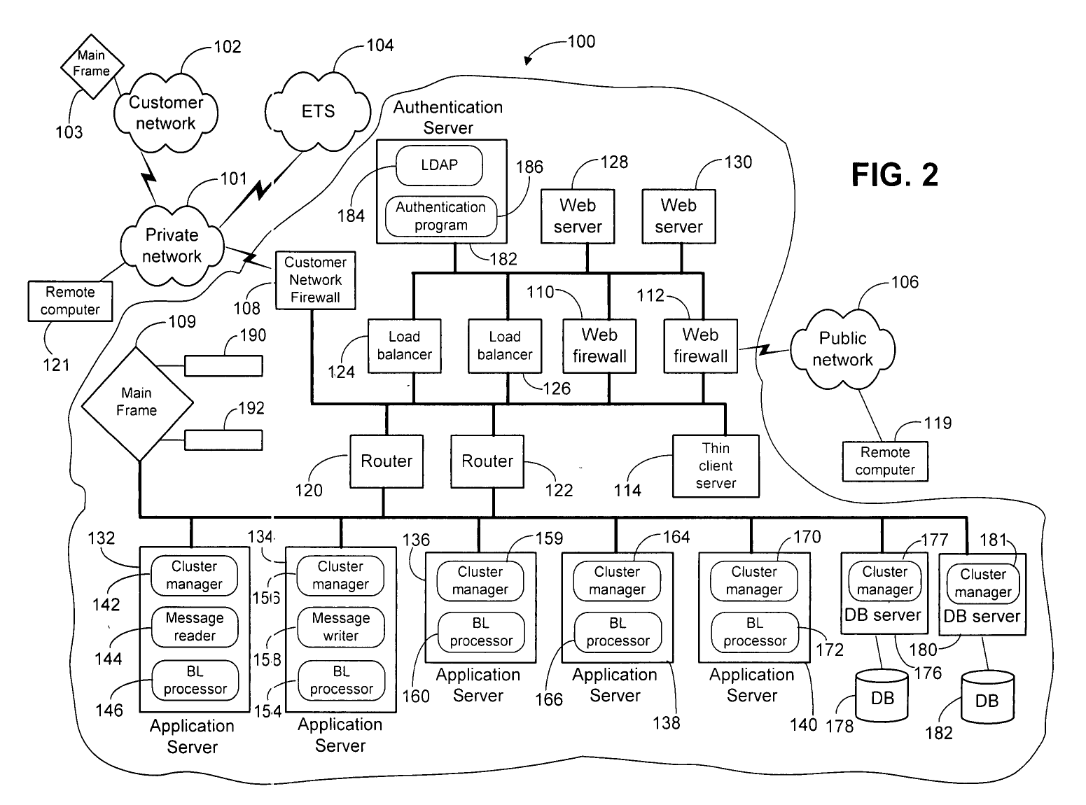

There are a variety of ways to implement the computer system of FIG. 1. One implementation is shown in FIG. 2, in which the ACT and NTM systems co-exist within the same network and same set of servers. The system, referred to herein as the data management system 100, is operated by a derivatives clearinghouse. The data management system 100 is communicatively linked with a private network 101. The private network 101 may be implemented in a variety of ways, including virtual private networking over the Internet or dedicated land lines. A customer network 102, and an electronic trading system (ETS) 104 are communicatively linked to the private network 101 and gain access to the data management system 100 via the private network 101. The data management system 100 is also communicatively linked to a public network 106. The customer network 102 represents the internal network of one of the participants of the clearinghouse, and includes a mainframe computer 103. It should be understood that there may be many customer networks communicating with the system 100, each with its own mainframe computer or computers. The ETS 104 represents the computer network of an electronic exchange. The public network 106 represents a publicly-accessible network such as the Internet, and includes a remote computer 119. Similarly, the private network 119 also includes a remote computer 121. In the examples discussed below, the remote computers 119 and 121 are assumed to be located at the place of business of one of the participants of the clearinghouse. Conceivably, some participants of the clearinghouse may access the data management system 100 via the private network 101, others may access the data management system 100 via the public network 106, while still others may use both the public and the private networks.

Communication between the data management system 100 and either the customer network 102 or the ETS 104 is generally carried out using some form of mainframe-to-mainframe protocol, such as MQ messaging. Communication between the data management system 100 and the remote computers 119 and 121 is generally carried out through a web-based interface using standard protocols such as TCP/IP and HTTP. When accessing the data management system 100, either through the public network 106 or through the private network 101, users generally use a personal computer executing a browser program. Remote computers 119 and 121 each represent such a personal computer (or functional equivalent thereof). Alternatively, users on the customer network 102 or the ETS 104 may communicate with the data management system 100 using mainframe messaging, in which they generally do not receive a graphical user interface (GUI) from the data management system 100.

The data management system 100 includes a customer network firewall 108 that regulates the ability of participant firms to access the data management system 100 from the customer network 102 and the ETS 104. The data management system 100 also includes a first web firewall 112 and a second web firewall 110 that regulate the ability of participant firms to access the data management system 100 from the public network 106. The first and second web firewalls 110 and 112 are each capable of load balancing, so that if one of them becomes much busier than the other, the busier web firewall can divert incoming web traffic to the other web firewall.

To assist users who may wish to have access through the public network 106, the data management system 100 has a thin client server 114. Users have the option to use the thin-client server 114 to compensate for having a low bandwidth connection over the public network 106. Users who require such access simply download thin-client software onto their workstation (e.g. the remote computer 119), and connect to the thin client server 114 over the public network 106. The data management system 100 treats the thin client server 114 as if it is part of the public network 106. Thus, data coming from the thin client server 114 is required to pass through one of the web firewalls 112 or 114.

The data management system 100 also includes a first web server 128 and a second web server 130. The web servers 128 and 130 store and manage web page content, and provide a GUI to users who access the data management system 100 through the public network 106 or the private network 101. Traffic to each of the web servers 128 and 130 is regulated by either a first load balancer 124 or a second load balancer 126. As the requests for web pages come in from the public network 106, the load balancers 124 and 126 allocate those requests to the first and second web servers 128 and 130 in a round-robin fashion so as to avoid overworking either web server. The second load balancer 126 acts as a back-up to the first load balancer 124, and can take over the first load balancer's job if the first load balancer 124 fails. There are a variety of possible implementations for the first and second load balancers 124 and 126. Examples include products by F5 Networks, Linux Virtual Server, and products by FalconStor Software®.

To authenticate users, the data management system 100 includes an authentication server 182. The authentication server 184 executes an authentication program 186, such as RSA ClearTrust®, SiteMinder® by Netegrity®, or IBM Tivoli Access Manageer. The authentication server 184 also executes a Lightweight Directory Access Protocol (LDAP) program 184. The authentication server 182 cooperates with the first and second web servers 128 and 130 to verify the identity and credentials of users accessing the data management system 100 via the public network 106.

The data management system 100 further includes a first router 120 and a second router 122. The first router 120 and the second router 122 direct network data traffic to various parts of the data management system 100 according to a set of rules relating to the IP addresses of the senders. Like the first and second web firewalls 112 and 114, the first and second routers 120 and 122 are capable of load balancing with one another, so that if one router becomes excessively busy, it can divert data traffic to the other router.

The data management system 100 also has a mainframe computer 109. The mainframe computer 109 is used by the data management system 100 to communicate with the customer network 102 and with the ETS 104 via the private network 101. The mainframe computer 109 has an incoming message queue 190 and an outgoing message queue 192. Messages received from the customer network 102 or the ETS 104 are stored in the incoming queue 190, while messages intended to be sent to the customer network 102 or the ETS 104 are stored in the outgoing queue 192. In one embodiment, the mainframe computer 109 executes an MQ messaging program, and communicates with the customer network 102 and the ETS 104 using MQ-formatted messages.

The data management system 100 further includes a first application server 132, a second application server 134, a third application server 136, a fourth application server 138 and a fifth application server 140. The programs executing on the first application server 132 include a cluster manager 142, a message reader 144, and a business logic processor 146. Similarly, the respective second, third, fourth and fifth application servers 143, 136, 138 and 140 have programs executing thereon. Table 1 below summarizes the programs executing on each of the application servers.

| | |
|---|---|
| Executing on | cluster manager 142 |
| the first | message reader 144 |
| applicaton | business logic (BL) processor 146 |
| server 132 | |
| Executing on | cluster manager 156 |
| the second | message writer 158 |
| application | business logic (BL) processor 154 |
| server 134 | |
| Executing on | cluster manager 159 |
| the third | business logic (BL) processor 160 |
| application | |
| server 136 | |
| Executing on | cluster manager 164 |
| the fourth | business logic (BL) processor 166 |
| application | |
| server 138 | |
| Executing on | cluster manager 170 |
| the fifth | business logic (BL) processor 172 |
| application | |
| server 140 | |

The first through fifth application servers operate in coordination with each other in a cluster. Each of the first through fifth application servers 132, 134, 136, 138 and 140 executes a cluster manager program 142, 156, 159, 164 and 170 respectively to facilitate this coordination. In general, the first and second application servers 132 and 134 process data received from the public network 106 (through a GUI on a browser), while the third, fourth and fifth application servers 136, 138 and 140 process data received from the customer network 102 and the ETS 104 (via MQ messages).

Each of the first through fifth application servers 132, 134, 136, 138 and 140 executes a respective business logic (BL) processor program 146, 154, 160, 166 and 172, which processes messages received from users of the data management system 100. It is these business logic processor programs that execute the computer code that underlies the ACT and NTM systems. The ACT and NTM code co-exists on each of the application servers.

When a message comes in from a user of the data management system 100, it is first screened by one of the firewalls, and is then routed by either the first or second router to one of the application servers. The application server that receives the message analyzes it according to the logic of a decision tree (described below in more detail). By traversing the decision tree, the application server can determine which pieces of computer code are to be invoked to perform operations on the data contained in the message. The decision tree itself is stored in the form of tables on a database server (which will also be described below in more detail), while the pieces of computer code are stored on the application server. In one embodiment, each of the application servers is a UNIX-based computer. The business logic processor program may be implemented in a variety of ways, including NET Server, by Microsoft®, IBM® WebSphere or JavaOne™ by Sun Microsystems™. The business logic that the business logic processor executes in this embodiment is implemented as a series of Java Beans that are associated with one another by the decision tree. By traversing the decision tree, the application server determines which Bean or Beans need to be invoked to process the message.

The data management system 100 also includes a first database server 176 and a second database server 180. The first database server 176 manages a database 178 that contains information regarding executed trades that have been accepted by the clearinghouse. The database 178 also contains tables that define the decision tree used by the application servers. The second database server 180 manages a database 182, which is a copy of the database 178 managed by the first database server 176. The first and second database servers 176 and 180 coordinate with one another as a cluster. To this end, the first database server 176 and the second database server 181 run cluster managers 177 and 181, respectively. The cluster managers 177 and 181 and the cluster manager programs on the application servers may be implemented in any of a number of ways, including IBM® eServer, Veritas™ cluster management software, or Beowolf by Aspen Systems. The database servers 176 and 180 also have a variety of possible database packages, including IBM® DB2, Oracle® Database 8i, or Microsoft® SQL Server software. The database systems may run on a variety of platforms, including UNIX, Windows, or Linux.

The first application server 132 and the second application server 134 also run programs for communicating with the mainframe computer 109. The first application server 132 executes a message reader 144 for reading messages from the incoming queue 190 of the mainframe computer 109, while the second application server 134 executes a message writer 158 for adding messages to the outgoing queue 192 of the mainframe computer 109. In an embodiment of the invention, the message reader 144 and the message writer 158 are each a client-side MQ messaging program. When a message comes in from the customer network 102 or the ETS 104, it is first screened by the customer network firewall. Then, either the first router 120 or the second router 122 routes it to the mainframe computer 109, which puts the message into the incoming message queue 190. The first application server 132 reads the message from the incoming message queue 190 and sends it to one or more of the third, fourth and fifth application servers 136, 138 and 140. The choice of which of these latter three application servers receives the message is made by the cluster manager 142 that executes on the first application server 132. The cluster manager 142 may determine that the most efficient way to process the message, for example, is to send it to the third, fourth and fifth application servers 136, 138 and 140 for parallel processing.

The first and second application servers 132 and 134 each interact with the first and second web servers 128 and 130 to provide dynamic content on the web pages that the first and second web servers 128 and 130 transmit to users who access the data management system 100 via the public network 106. For example, if a user on the public network 106 requests a web page that lists the most recently accepted executed trade for the user's trading firm (which is a participant of the clearinghouse), the first and second web servers 128 and 130 create the overall format of the web page, but the selection of which kind of trade data is to be displayed as well as the trade data itself is made by one or both of the first and second application servers 132 and 134.

The functionality that the data management system illustrated in FIGS. 1 and 2 provides to users, and the way in which that functionality is provided in an embodiment of the invention will now be described. As discussed previously, the execution of a trade occurs either in a trading pit, where the trade is conducted verbally, including the use of hand gestures, or through an electronic trading system. When a buyer and a seller commit to a price for which a future or option is to be bought/sold, and to any other required terms, the trade is said to have been “executed.” The buyer and the seller each enter data regarding the executed trade (or have this data entered for them) using some type of computer interface. Based on the entered data, two records for the executed are created: a record for the buyer and a record for the seller. These records are then sent to a clearinghouse to be matched (the open outcry method), or are first matched and then sent to the clearinghouse (the electronic trading method). An example of a scenario in which the records are sent unmatched to the clearinghouse is as follows. Referring to FIG. 2, a first broker offers to sell a certain quantity of corn futures on the floor of a derivatives exchange. A second broker on the derivatives exchange accepts the offer.

A clerk working for the first broker's firm enters the first broker's record of the trade (i.e. the seller's record) into a terminal connected to the mainframe 109 of the customer network 102. The mainframe 103 creates an MQ message representing the first broker's record and transmits the message through the private network 101 to the data management system 100. The message is screened by the customer network firewall 108, and permitted to pass to the first router 120. The first router 120 routes the message to the mainframe 109 of the data management system 100. The mainframe 103 puts the message into the incoming message queue 190. The message reader 144 of the first application server 132 subsequently reads the message from the incoming message queue 190. The first application server 132 then transmits the message to the third application server 136.

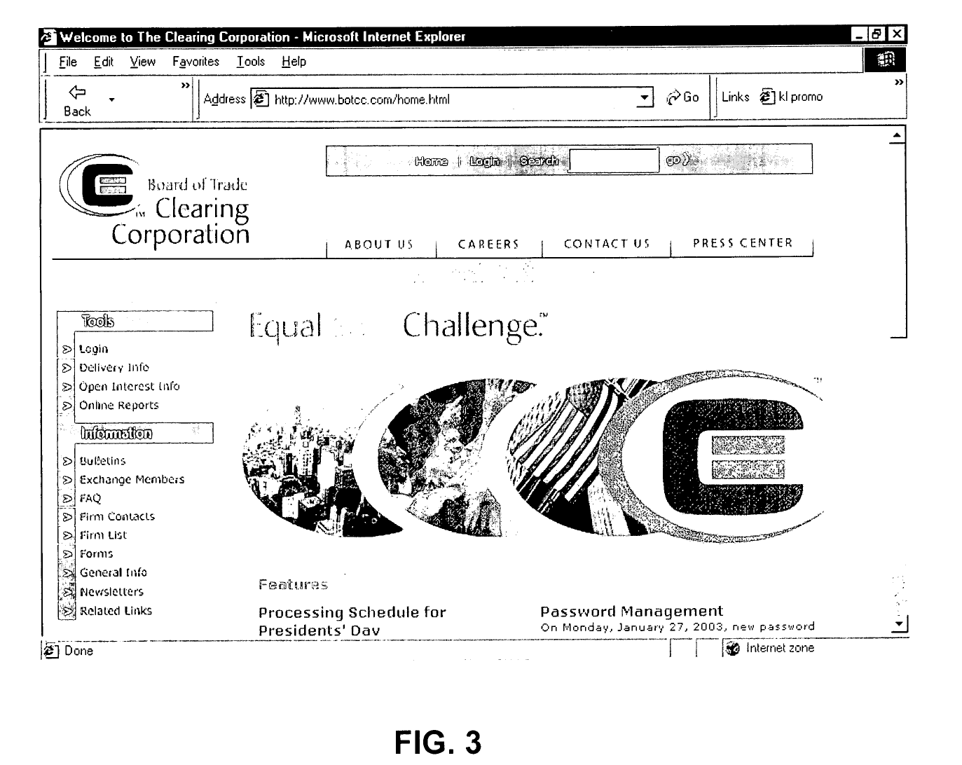

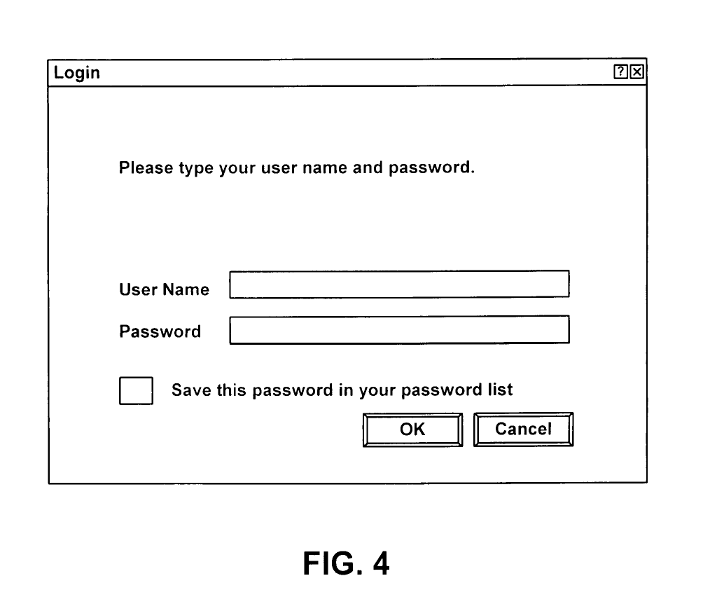

A clerk working for the second broker's firm logs on to the remote computer 119 and executes a web browser program. Through the web browser program, the clerk accesses the data management system 100 over the public network, and requests the home page of the data management system 100. After the request is screened by the first web firewall 112, it is permitted to pass to the first router 120. The first router 120 routes the request to the first web server 128. The first web server 128 transmits the homepage to the remote computer 119. FIG. 3 shows an example of such a home page. The clerk then selects “login.” In response, the first web server 128 transmits a login dialog box (FIG. 4). The clerk then logs in. The clerk enters a username and password, which is transmitted back to the first web server 128. The first web server 128 relays the username and password to the authentication server. The authentication program 186, in conjunction with the LDAP program 184, verifies the username and password, and indicates to the first web server 128 that it is OK to continue interacting with the remote computer 119. The first web server 128 then provides a web page to the remote computer 119 that allows the clerk to enter the second broker's record of the executed trade (i.e. the buyer's record) into the remote computer 119. The second broker's record is then transmitted to the first web server 128 using standard Internet protocols. The first web server 128 transmits this record to the third application server 136 (via the first router 120).

The third application server 136 works in cooperation with the first DB server 176 to store both the first broker's record of the executed trade and the second broker's record of the executed trade in the database 178 maintained by the first DB server 176. The data management system 100 will eventually attempt to match the first broker's record and the second broker's record with one another so that the clearinghouse can clear the executed trade.

If the trade between the first broker and the second broker took place on an electronic exchange in which the buyer's and seller's records of the executed trade were already matched by the time the data is received by the data management system 100, the process would occur as follows. The ETS 104 creates an MQ message representing both the first and second broker's record of the trade (pre-matched) and transmits the message through the private network 101 to the data management system 100. The message is screened by the customer network firewall 108, and permitted to pass to the first router 120. The first router 120 routes the message to the mainframe 109 of the data management system 100. The mainframe 103 puts the message into the incoming message queue 190. The message reader 144 of the first application server 132 subsequently reads the message from the incoming message queue 190. The first application server 132 then transmits the message to the third application server 136. The third application server 136 works in cooperation with the first DB server 176 to insert the record of the executed trade in the database 178 maintained by the first DB server 176. If appropriate, the clearinghouse will subsequently accept the executed trade.

Periodically, the data management system 100 runs a “match cycle,” in which it attempts to match each buyer's trade record stored in the databases of the first and second DB servers 176 and 180 with a corresponding seller's record. At the end of each trading day, the data management system 100 tallies up the gains and losses for each of the participants of the clearinghouse, and calculates a final monetary value for each participant for that day. Each gain is treated as a positive number, while each loss is treated as a negative number. Whether or not a trade is a gain or loss for a buyer or seller requires a calculation of the difference between the closing price of the derivative that was traded and the price for which the derivative was bought or sold. In general, every trade results in either the buyer or seller having a “gain” and the opposing party having a “loss” with respect to that trade. It is also possible for both parties to come out “even.” The day-end monetary value for each participant is either a debit or a credit. If a participant ends the trading day with a net debit, then the clearinghouse deducts the amount of the debit from the participant's bank account. Likewise, if the participant ends the trading day with a net credit, then the clearinghouse adds the amount of the credit to the participant's account. This daily “marking-to-market” of trades that have been accepted by the clearinghouse is referred to as “settlement.”

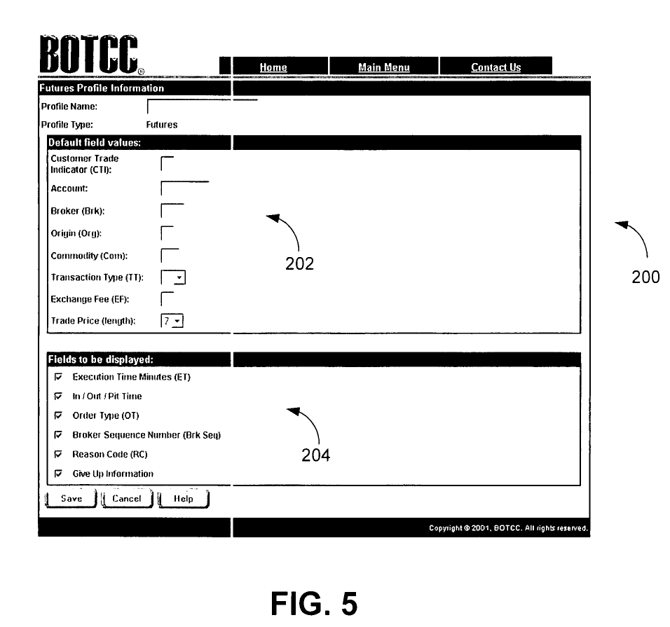

According to an embodiment of the invention, the data management system 100 of FIG. 1 allows a user to customize the appearance of a trade entry screen. The trade entry screen may be used on the floor of a derivative trading marketplace to enter data regarding one or more trades that have been previously executed in the derivative trading marketplace. A user may, for example, choose which data entry fields are to be displayed on the trade entry screen. Once the user determines which data entry fields are to be displayed on the trade entry screen, the user may choose which of those data entry fields, if any, are to receive default values and what those default values are. Collectively, the user's preferences regarding the appearance of his or her trade entry screen are referred to as the user's “profile.” A user may set up any number of profiles. For example, the user can set up a different profile for each commodity that the user trades. The user may set up a profile through a setup interface. An example of such a setup interface is shown in FIG. 5. The setup interface 200 has a list 202 of the available entry fields for which the user may specify default values, and a list 204 of information fields that the user may select to be displayed. Once the user enters the field values in the entry field list 202, and selects which information fields of the information field list 204 are to be displayed, the data management system 100 stores these preferences in a database. For the system depicted in FIG. 1, the database in which the profile is stored is the profile database. For the data management system 100 of FIG. 2, the user's profile is stored in the databases 178 and 182 maintained by the first and second database servers 176 and 180.

An example of how a user establishes a profile using the interface of FIG. 5 will now be described. In this example, it is assumed the user wishes to have the following default values for his or her trade entry screen.

| | Default | |
|---|---|---|
| Field Name | value | Meaning |
| Customer Trade Indicator | 4 | Executed for the |
| (CTI) | | benefit of some other |
| | | party |
| Account | (none) | No default value |
| Broker (Brk) | DBT | Trades executed by a |
| | | broker using this |
| | | acronym |
| Origin (Org) | 1 | The trade is for a |
| | | customer account |
| Commodity (Com) | C | The commodity on the |
| | | trade execution is corn |
| Transaction Type (TT) | 6 | It is a spread |
| | | transaction |
| Exchange Fee (EF) | (none) | No default value |
| Trade Price (length) | 6 | Six characters are |
| | | required to identify |
| | | the actual price. |

The user enters these values in the appropriate fields of the interface of FIG. 5. The user may modify one or more field values by going back to that specific field or the user may select the “cancel” button.

Referring again to FIG. 5, the user also has the option to select what information is to be displayed on the trade entry screen. For example, the user may select one or more of the following:
Execution Time in Minutes (ET)
In/Out/Pit Time
Order Type (OT)
Broker Sequence Number (Brk Seq)
Reason Code (RC)
Give Up Information
   In FIG. 5, all of these types of information have been selected from the information field list, and, thus, all of these types of information will appear on the user's trade entry screen.

Once the user has configured the trade entry screen according to his or her preferences, the user can begin entering executed trades. The use of the trade entry screen to enter data regarding trades that have already been executed is illustrated as follows. A clerk of a participant firm of a derivatives clearinghouse receives written details regarding a trade previously executed between one of the firm's brokers and an opposing broker on the floor of a derivatives exchange. The clerk logs into the data management system 100 via the public network 100 and receives the trade entry screen from the first web server 128. The clerk then enters data regarding the executed trade. Such data includes the identity of the opposing broker's firm, the initials of the opposing broker, the commodity that underlies the derivative and the selling price. A second clerk, working for the opposing broker's firm, also receives written details regarding the trade, and does the same thing. The data management system 100 creates two records for the trade and stores those two records in the databases of the first and second database servers 176 and 180.

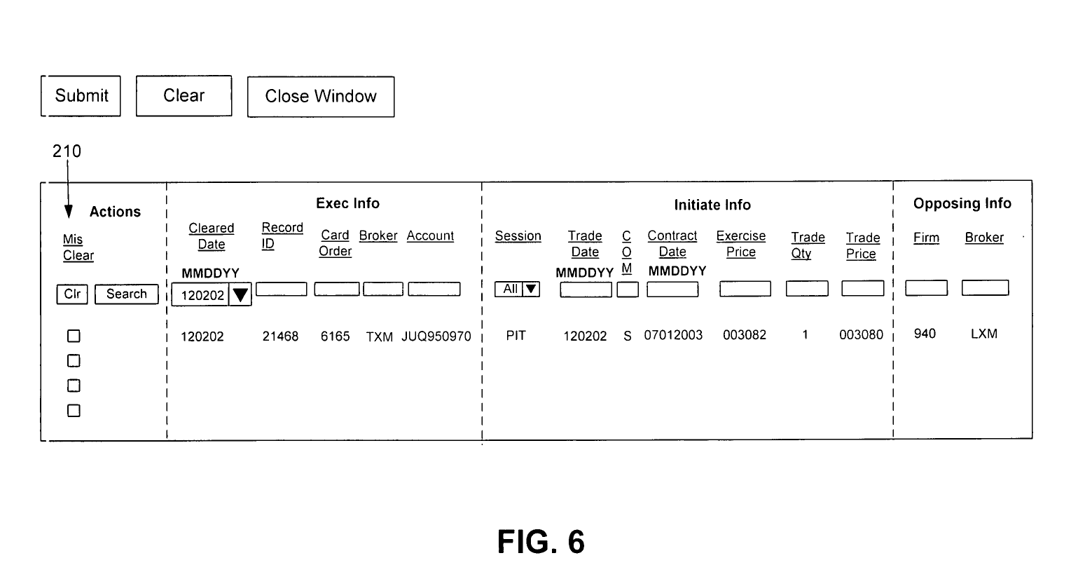

In various embodiments of the invention, the data management system of FIG. 2 maintains a database of cleared trades and, upon the request of users, displays the summary of the cleared trades. In one embodiment, data regarding the trades are maintained for four or five days after they are cleared. An example of a user interface for displaying the summary of cleared trades to a user is shown in FIG. 6. If a user determines that a cleared trade listed in the summary is incorrect in some way (as a result, for example, of an internal reconciliation procedure conducted by the user's trading firm), the user may designate the cleared trade as a “misclear” by checking a box in the first column 210. The data management system 100 responds by automatically generating a new transaction that offsets the miscleared trade. The data management system 100 then transmits a message to the opposite party involved in the original miscleared trade. The message gives the opposite party the option to “claim” (accept) the new transaction. If the other party claims the new transaction, then, in effect, a new, offsetting transaction is created. The clearinghouse then clears the new transaction and generates a new record in the database corresponding to the new transaction. Thus, the originally miscleared trade gets nullified.

A more detailed example of how the misclear feature of the data management system 100 operates according to an embodiment of the invention will now be described. In this example, it is assumed that a trade occurs between two pit traders in a commodity exchange—the first trader being the buyer and the second trader being the seller. Through a series of very quick hand signals, the first trader agrees to buy March corn at $5.10 from the second trader. The first trader's clerk and the second trader's clerk both erroneously enter the price of the transaction as $5.11. Furthermore, the first and second traders' firms do not catch the mistake, and allow the trade to be matched. The clearinghouse therefore accepts the trade and the data management system 100 creates a record for the trade in the databases of the first and second database servers 176 and 180. The record is classified under the category of “cleared trades.”

Upon later review, the second trader realizes the mistake. Using the remote computer 119, the second trader requests a summary of cleared trades from the data management system 100. In response, the data management system 100 retrieves, from the either of databases 178 and 182, records for those tradess in which the second user was a party. The ACT server then transmits a summary of cleared trades to the second user device, which displays the summary in the form of an interface like the one shown in FIG. 6. The second user locates the entry for the erroneously recorded trade in the summary, checks the “misclear” box to the left of the entry, and activates the “submit” button. The data management system 100 responds by electronically generating a new, offsetting transaction. The offsetting transaction reflects a purchase, by the second trader (who was the seller), of March corn at $5.11 from the first user (who was the buyer). The data management system 100 then notifies the first trader that the second trader wishes to negate the clearinghouse's acceptance of the trade. This notification may take the form of an electronic message that gets put onto the second trader's user interface. The electronic message asks the first trader whether the first trader wishes to claim or reject the transaction. In response, the first trader accepts the transaction. In other words, the first trader agrees that the original trade had been improperly accepted. In response, the data management system 100 creates a record for a new transaction (the purchase of March corn by the second trader from the first trader at $5.11). The new transactino is then designated as “accepted” in the databases of the first and second database servers 176 and 180. The record for the new transaction is then entered into the cleared trades database. Note that this new transaction is not based on a new trade, in the sense that the second trader did not actually purchase March corn at $5.11 from the first trader. The new transaction is simply a database record that is created for the purpose of having an audit trail and to enable the erroneously cleared trade to be backed out. This new record offsets the record of the original trade.

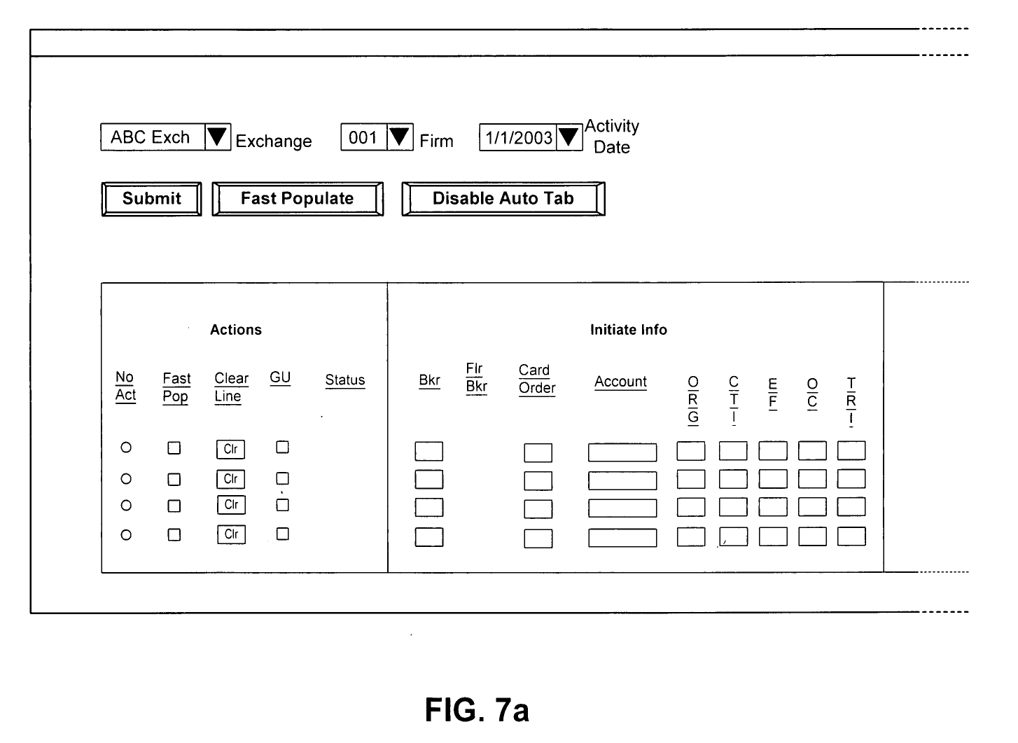

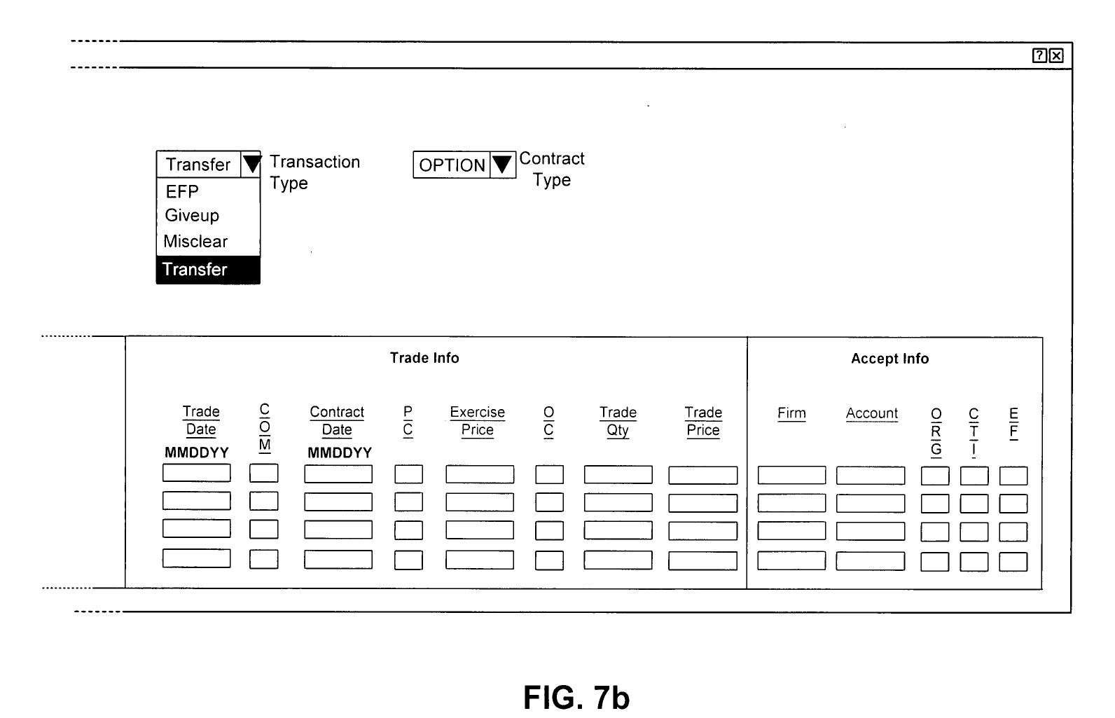

According to an embodiment of the invention, the data management system 100 (FIG. 2) allows a participant of a clearinghouse to initiate a one-sided transfer of a position to another participant. A “position” is a term used to describe the obligation of a buyer or seller with respect to a particular future or option contract. For example, assume that the first participant is the ABC Trading Firm, whose client is Acme Investment Corp. Acme Investment Corp. wishes to move its positions from the ABC Trading Firm to the second participant, the XYZ Trading Firm. To effect the move, a clerk at the ABC Trading Firm interacts with the data management system 100 via the remote computer 119 to obtain a position-transfer interface from the first web server 128. An example of a position transfer interface is shown in FIGS. 7a and 7b, with FIG. 7a showing the left portion and FIG. 7b showing the right portion. The position transfer interface includes fields for identifying the positions to be transferred. The clerk at the ABC Trading firm then fills a field for each of the positions belonging to the Acme Investment Corp. For example, if the Acme Investment Corp. has forty positions, including a mix of long and short positions on various commodities, the clerk enters the transaction identifier for each of the forty transactions. The clerk then enters the ID number of the second user (the XYZ Trading Firm) and activates a “submit” button. The data management system 100 sends one or more messages to the ABC Trading Firm, asking whether or not the ABC Trading Firm accepts the positions that the XYZ Trading Firm is attempting to transfer. If the XYZ Trading Firm accepts the positions, the data management system 100 automatically reflects the transfer in the databases of the first and second database servers 176 and 180. In addition to transferring positions, a variation of the above-described interface can also be used to transfer money from one firm to another. Instead of identifying positions, the ABC Trading Firm just enters a monetary amount and, optionally, comments explaining why the transfer is occurring. The XYZ Trading firm gets a notification and either accepts or declines the money transfer.

According to yet another embodiment of the invention, the data management system 100 allows a user to verify the validity of the customer's positions being transferred. The process carried out to accomplish this verification is referred to as an “equity run.” During an equity run, the data management system 100 calculates open trade equity values based on the settlement prices of the previous day's cleared trades.

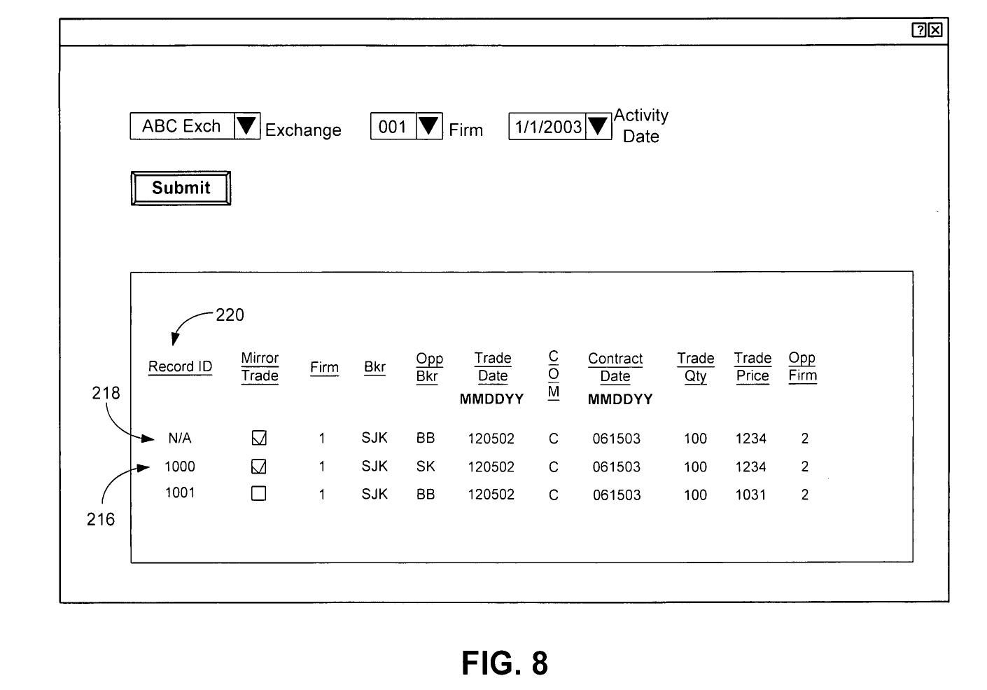

As has been previously discussed, when a trade occurs on a derivatives exchange, the buyer and seller will each enter data regarding the trade, thereby creating two separate records of the trade. To clear the trade, the clearinghouse will then have to match the two records to insure that certain critical data in the two records matches. An example of such critical data is the buy or sell price. Thus, the buyer's record and the seller's record should both show the same price. However, due to human error, either the buyer or seller may have made a mistake in entering the data. In an embodiment of the invention, the data management system 100 permits a user, who works for either the buyer or seller, to pull up the unmatched trades and determine whether the mistake was made on the part of the user's firm. If so, and if the party on the opposite side of the trade has the correct data in its record, the user can request that the data management system 100 simply edit the record of the user's firm so that it becomes identical to the opposing party's record. FIG. 8, shows a user interface in which this is done. In the example of FIG. 8, the unmatched trade records are sorted on the screen so as to increase the likelihood that records involving opposite sides of the same underlying trade are listed closely together. In FIG. 8, the first two entries in the list of unmatched trade records have identical substantive information, that the second entry has the opposing broker as “SK.” Note that the record ID of the first entry in the list contains the value “N/A.” This simply means that the record is one that the user's firm did not enter into the system, but rather represents data entered by a firm other than the user's firm. The data in the first entry does, however, correspond to a trade to which the user's firm was a party. The user will analyze this list and determine that the second entry is erroneous, because the opposing broker should have been “BB.” The user thus selects the second entry, since it is the one that was erroneous, and the first entry, which the user has determined represents the same trade as the second entry and which, in the determination of the user, contains the correct data (i.e. has the opposing broker listed as BB). Once the user clicks on the “submit” button, the database entry in the database 178 that corresponds to the second trade on the list is changed so that the information now matches that of the opposing party's (e.g. the opposing broker field now has “BB” instead of SK). In other words, the data management system 100 alters the second entry—the one with data entered by the user's firm—so that it now “mirrors” the data in the first entry—which was entered the opposing broker's firm.

Periodically, the data management system 100 searches through the database 178 of the first database server 176 (and its twin, the database 182 of the second database server 180) and attempts to match pairs of records, so that for each record entered by a buyer, there is a matching record entered by a seller. Once the records have been matched, the derivatives trade that those matched records represent can be accepted by the clearinghouse, and eventually designated as being cleared in the databases of the first and second database servers 176 and 180. Referring again to FIG. 8, once the user selects the first and second entries to be mirrored, and the data of the second entry is updated in the database, the data management system 100 will, during the next matching cycle, match the two records corresponding to the first and second entries. The trade that underlies those two matched records will then be cleared by the clearinghouse.

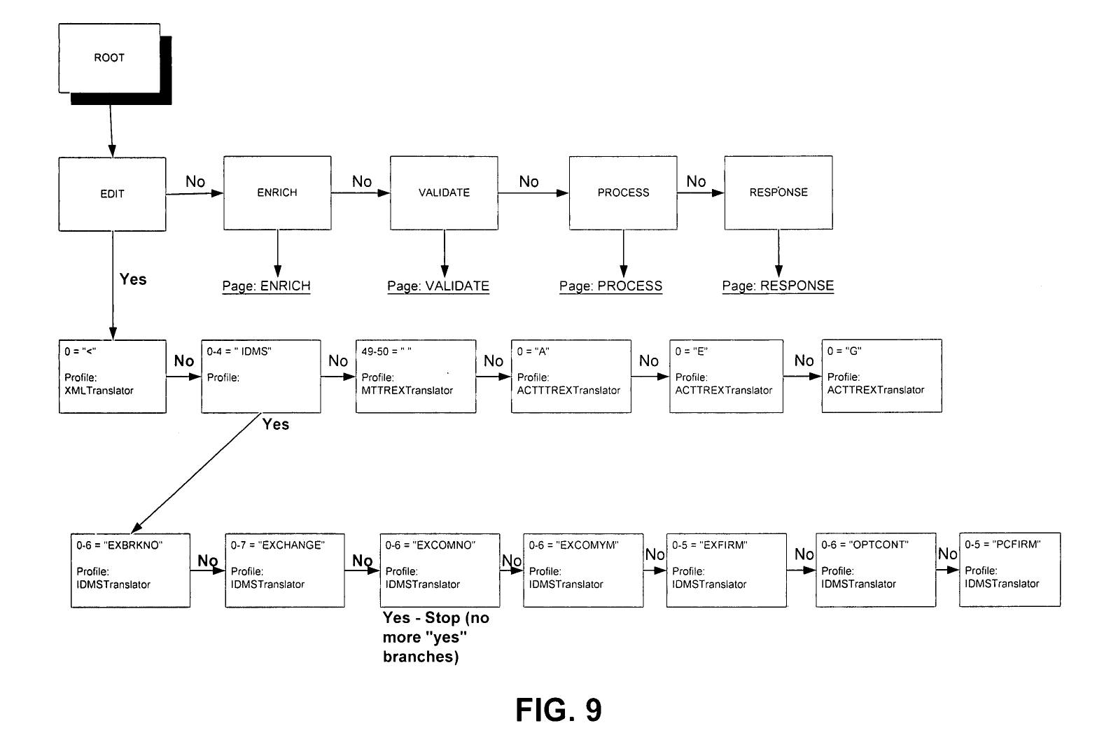

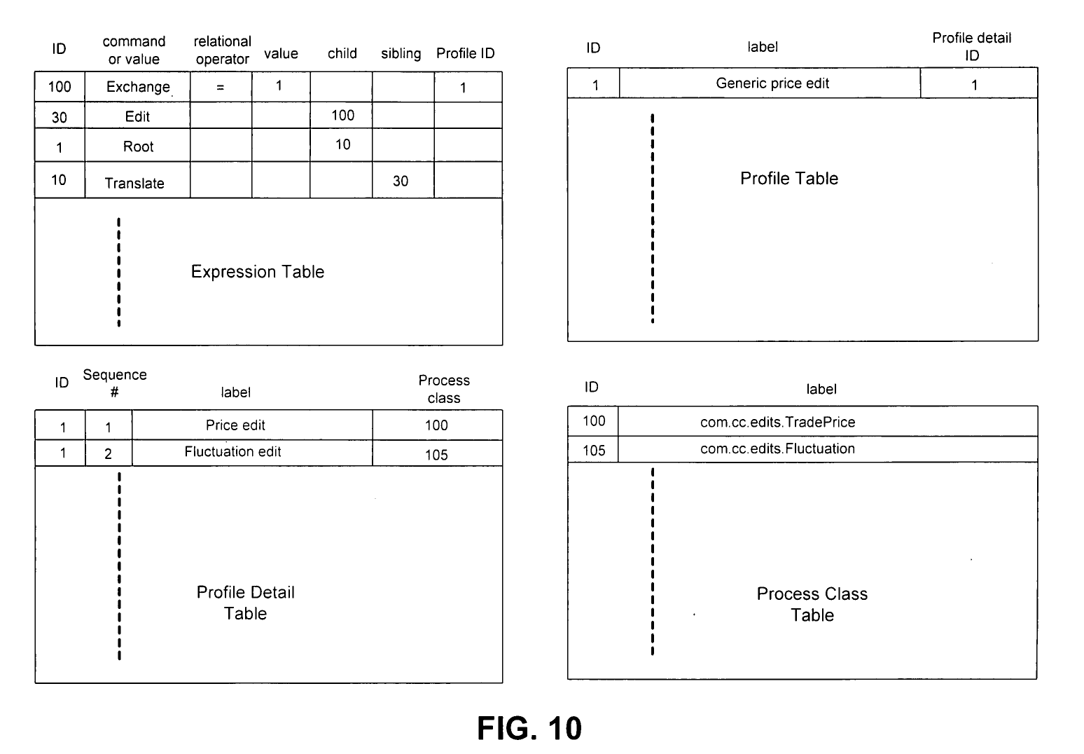

As discussed above, each of the application servers 132, 134,136, 138 and 140 of the data management system 100 (FIG. 2) executes business logic to process incoming data from the public network 106 or the private network 101. In one embodiment, the business logic is executed on the Websphere platform, in which a logical decision tree is traversed to determine which Java Bean or Beans need to be invoked to process the incoming data. An example of such a tree is shown in FIG. 8. An example of how this occurs will now be described with reference to FIG. 2, with reference to FIG. 9, and with reference to FIG. 10, which shows a set of tables that are stored in the database 178 of the first database server 176. Assume that the ETS 104 (FIG. 2) transmits a message through the private network 101. The customer network firewall 108 permits the message to pass through the system 100 and to the clearing house's mainframe computer 109, where it is placed into the incoming message queue. The message reader program 144 of application server A retrieves the message, and passes the message to the third application server 136. The third application server 136 then analyzes the message according to a decision tree stored in the database 178 of the first database server 176. The third application server 178 determines that the message needs to be edited into a standard format that the data management system 100 can use. This translation is represented by the “edit” branch of FIG. 9. The third application server 136 passes a command data structure containing the command “edit” along with a set of parameters back to the root of the decision tree.

Referring now to FIG. 10, in which the decision tree is shown broken down into its constituent tables, the process of walking through the EDIT branch of the tree of FIG. 9 will now be described. Starting at the Expression Table (FIG. 10), the row having an ID of 1 represents the root of the tree. Analyzing that row, the third application server 136 determines that, since there is no expression in that row, and that the child of the row has an ID of 10, it needs to jump to the row with the ID of 10 (Row #10). The third application server 136 then compares the command “edit” with the command listed in that row, which is “translate.” Since “edit” is not the same as “translate,” the third application server 136 determines whether Row #10 has any siblings. The third application server 136 determines that there is a sibling, which is Row #30, and jumps to the sibling. At the sibling (Row #30), the third application server 136 finds that the command listed in that row is “edit.” Since “edit” now evaluates as “true,” the third application server 136 jumps to the child of Row #30, which is Row #100. Row #100 indicates that if the Exchange ID=1, then profile 1 is to be used. In this example, the Exchange ID does equal 1, so the third application server 136 goes to the Profile Table and obtains the data in Row #1 of that table. Row #1 of the profile table corresponds to the profile Generic Price Edit. Furthermore, profile detail ID is 1, which indicates to the third application server 136 that it should go to the Profile Detail Table and start obtaining details having an ID of 1. In the Profile Detail Table, there are two profile details (rows) having an ID of 1. The first in sequence is “price edit.” It corresponds to process class #100. The third application server 136 refers to the process class table and finds the identifier for class #100, which is “com.cc.edits.TradePrice.” The third application server 136 then creates an instance of the class com.cc.edits.TradePrice, which is implemented in this embodiment as a Java Bean. The Bean contains the code required to perform the function “price edit.” Once that code has been executed, the third application server 136 goes to the next detail in the Profile Detail Table for profile 1.

The next detail in the sequence is “fluctuation edit,” is associated with class #105. The application server C refers to the row of the Process Class Table having an ID of 105. As shown in FIG. 10, that row indicates that the identifier for class #105 is “com.cc.edits.Fluctuation.” The third application server 136 then creates an instance of the class com.cc.edits.Fluctuation, which is implemented in this embodiment as a Java Bean. The Bean contains the code required to perform the function “fluctuation.” Once that code has been executed, the third application server 136 returns to the root of the decision tree and either performs functions according to another branch of the decision tree or waits for the next message to be passed to it.

It can thus be seen that a new and useful method for managing data regarding derivatives trades has been described. While preferred embodiments of this invention are described herein, including the best mode known to the inventors for carrying out the invention, it should be understood that the illustrated embodiments are examples only, and should not be taken as limiting the scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method for reversing the clearance of a previously executed derivatives trade, in which a buyer and a seller have executed the trade in a derivatives exchange or in an over the counter market, the method comprising:
storing data, in a memory, indicating that the executed trade has been accepted;
in response to an electronic request from a user, retrieving the accepted-trade data from the memory;
displaying the retrieved data to the user on a user interface;
receiving an input from the user indicating that the acceptance of the executed trade should be negated;
in response to the received input, generating an offsetting transaction record for the buyer and an offsetting transaction record for the seller, in which the buyer's and seller's roles are reversed from what they were in the executed trade; and
repeating the storing step using the offsetting transaction records for the buyer and seller, thereby negating the acceptance of the executed trade.

2. The method of claim 1, further comprising:
receiving the buyer's record of the executed trade and the seller's record of the executed trade;
comparing the buyer's record and the seller's record to determine whether certain fields in the buyer's record match equivalent fields in the seller's record; and
based on the comparing step, accepting the executed trade.

3. The method of claim 1, further comprising:
receiving a matched trade from an electronic exchange or over the counter market, wherein the matched trade represents the executed trade; and
accepting the matched trade.

4. The method of claim 1, wherein the displaying step comprises:
transmitting, to a remote computer, a graphical user interface comprising a plurality of rows and columns, wherein each row represents a particular derivatives trade that had been previously executed and accepted, and each column represents a piece of information concerning the particular trade.

5. The method of claim 2,
wherein the buyer and seller represent participants of a clearinghouse or are customers of clearinghouse participants;
wherein the buyer bought the derivative from the seller on a first trading day;
wherein the step of receiving the buyer's and the seller's records of the executed trade comprises receiving, in the buyer's record and in the seller's record, data that identifies the commodity that was traded, identifies the buyer and the seller, and identifies the price at which the commodity was traded;
wherein the step of accepting the executed trade comprises assuming one or more obligations of the buyer and seller with respect to the executed trade;
the method further comprising:
tallying up all of the gains and losses for both the buyer and seller at the end of the first trading day, including the trade carried out between the buyer and seller, and crediting or debiting the bank accounts of the buyer and seller based on the results of the tallying step;
tallying up all of the gains and losses for both the buyer and seller at the end of a second trading day, taking into account offsetting transaction records, and crediting or debiting the bank accounts of the buyer and seller based on the results of the tallying step, thereby negating the acceptance of any previously executed trades that are intended to be negated by any offsetting transactions.

6. The method of claim 2,
wherein the buyer and seller represent participants in a clearinghouse;
wherein the buyer and seller executed the trade on a first trading day;
wherein the step of receiving the buyer's and the seller's records of the executed trade comprises receiving, in the buyer's record and in the seller's record, data that identifies the commodity that was traded, identifies the buyer and the seller, and identifies the price at which the commodity was traded;
the method further comprising:
tallying up all of the gains and losses for both the buyer and seller at the end of a first trading day, including the executed trade, and crediting or debiting the bank accounts of the buyer and seller based on the results of the tallying step;
wherein the displaying step further comprises transmitting, to a remote computer, a graphical user interface comprising a plurality of rows and columns, wherein each row represents one of a plurality of derivatives trades that had been previously executed and accepted, and each column contains one of a plurality of pieces of information concerning each of the plurality of derivatives trades; and
tallying up all of the gains and losses for both the buyer and seller at the end of a second trading day, taking into account offsetting transaction records, and crediting or debiting the accounts of the buyer and seller based on the results of the tallying step, thereby negating the effect of the previous acceptance of any executed trades that are intended to be negated by any offsetting transactions.

7. The method of claim 6, wherein the graphical user interface is a web page, and the plurality of pieces of information comprises: the date on which the plurality of trades were accepted, the broker that executed the trade underlying the trade, and the commodity that was traded.

8. The method of claim 1, wherein the buyer and the seller are participants in a clearinghouse, wherein there is a first party to the executed trade, who is either the buyer or the seller, and there is a second party to the executed trade, who is on the opposing side of the first party, wherein the user represents the first party to the executed trade, the method further comprising:
displaying a message to the second party on a display screen, wherein the message queries the second party regarding whether the second party agrees that the executed trade should not have been accepted; and
receiving an input from the second party that indicates that the second party agrees that the executed trade should not have been accepted.

9. The method of claim 2,
wherein the buyer and seller represent participants in a clearinghouse;
wherein the buyer and seller executed the trade on a first trading day;
wherein the step of receiving the buyer's and the seller's records of the executed trade comprises receiving, in the buyer's record and in the seller's record, data that identifies the commodity being traded, identifies the buyer and the seller, and identifies the price at which the commodity was traded;
the method further comprising:
tallying up all of the gains and losses for both the buyer and seller at the end of the first trading day, including the executed trade, and crediting or debiting the bank accounts of the buyer and seller based on the results of the tallying step;
wherein the displaying step further comprises transmitting, to a remote computer, a graphical user interface comprising a plurality of rows and columns, wherein each row represents one of a plurality of trades that had been previously executed and accepted, and each column contains one of a plurality of pieces of information concerning each of the plurality of trades;
tallying up all of the gains and losses for both the buyer and seller at the end of a second trading day, taking into account offsetting transaction records, and crediting or debiting the bank accounts of the buyer and seller based on the results of the tallying step, thereby negating the effect of the acceptance of any executed trades that are intended to be negated by any offsetting transactions;
displaying a message to the second party on a display screen, wherein the message queries the second party regarding whether the second party agrees that the executed trade should not have been accepted; and
receiving an input from the second party that indicates that the second party agrees that the executed trade should not have been accepted.

10. A method for generating a graphical user interface for the entry of completed derivatives trades, the graphical user interface comprising a plurality of data entry fields for receiving data regarding the completed derivatives trades, the method comprising:
receiving a log-in comprising the identity of a user;
based on the identity of the user, selecting a profile from a plurality of profiles, the profile representing which data entry fields of the plurality are to be populated with default values, what the default values are, and which of a plurality of information fields are to be displayed on the user interface; and
generating the graphical user interface in accordance with the profile.

11. The method of claim 10, wherein the plurality of data entry fields comprises a field for identifying the commodity on which the traded derivative is based, and a field for identifying a broker who executed the trade.

12. The method of claim 10, wherein the plurality of information fields comprises a trade execution time field and an order type field.

13. The method of claim 10,
wherein the plurality of data entry fields comprises a field for identifying the commodity on which the traded derivative is based, and a field for identifying a broker who executed the trade; and
wherein the plurality of information fields comprises a trade execution time field and an order type field.

14. The method of claim 10, further comprising:
displaying the graphical user interface in a first frame;
checking a message queue;
retrieving an alert message from the queue;
displaying the alert message to the user in a second frame.

15. The method of claim 14, wherein the alert message relates to post-trading activity.

16. The method of claim 14, wherein the alert message alerts the user that all post-trading activity needs to stop.

17. The method of claim 10, wherein the user is a first participant in a derivatives trading clearinghouse, the method further comprising:
providing, to the first participant, a first graphical user interface having a list of a plurality of the user's trading positions;
receiving, from the first participant, a selection of one of the plurality of derivative trading positions;
receiving, from the first participant, an indication that the first participant wishes to transfer the selected derivative trading position to a second participant in the derivatives trading clearinghouse;
providing, to the second participant, a second graphical user interface that queries the second participant regarding whether the second participant wishes to assume the trading position itself;
receiving, from the second participant, an acceptance of the trading position; and
in response to receiving the acceptance, transferring the position from the first participant to the second participant.

18. The method of claim 17,
wherein the trading position is a long or a short position on a derivative, and
wherein the transferring step comprises editing a database so that the long or short position ceases to be associated with the first participant and starts being associated with the second participant.

19. The method of claim 10, wherein the user is a first participant in a derivatives trading clearinghouse, the method further comprising:
providing, to the first participant, a first graphical user interface having a money entry field;
receiving, from the first participant, an entry of an amount of money in the money entry field;
receiving, from the first participant, an indication that the first participant wishes to transfer the entered amount of money to a second participant in the derivatives trading clearinghouse;
providing, to the second participant, a second graphical user interface that queries the second participant regarding whether the second participant wishes to accept the money;
receiving, from the second participant, an acceptance of the money; and
in response to receiving the acceptance, transferring the money from a bank account of the first participant to a bank account of the second participant.

20. A method for reconciling unmatched records of derivatives trades, wherein the derivatives trades occurred in a derivatives exchange, wherein the derivatives exchange has a plurality of participants, the method comprising:
receiving a login from a user;
retrieving, from a database, a plurality of trade records, each trade record representing a derivatives trade in which a first participant of the plurality was either a buyer or a seller, each trade record being designated as unmatched;
displaying the plurality of trade records on a graphical user interface;
receiving, from the user via the graphical user interface, a selection of a first record and a second record of the plurality, wherein the first participant is listed as the buying party in the first record and a second participant of the plurality is listed as the buying party in the second record, and wherein the first and second record represent opposite sides of the same underlying trade;
in response to the user selection, automatically editing the contents of the first record so that the contents become identical to the contents of the second record; and
storing the edited contents of the first record in the database.

21. The method of claim 20, further comprising:
receiving from the first participant an entry of the contents of the first record;
searching the database for another record that represents the opposite side of the same underlying trade as the first record; and
upon failing to locate another such record, designating the first record to be unmatched.

22. The method of claim 20, further comprising:
receiving from the first participant an entry of the contents of the first record;
searching the database for another record that represents the opposite side of the same underlying trade as the first record;
upon failing to locate another such record, designating the first record to be unmatched;
after the storing step, matching the first record and the second record; and
after the matching step, accepting the underlying trade represented by the first and second records.

23. The method of claim 20, wherein the displaying step comprises sorting the plurality of trade records in such a way as to increase the likelihood that records that could match one another are ordered close together.

24. The method of claim 20, wherein the listing step comprises sorting the plurality of trade records in such a way as to increase the likelihood that records that could match one another are ordered close together, the method further comprising:
receiving from the first participant an entry of the contents of the first record;
searching the database for another record that represents the opposite side of the same underlying trade as the first record;
upon failing to locate another such record, designating the first record to be unmatched; and
after the storing step, matching the first record and the second record; and
after the matching step, accepting the underlying trade represented by the first and second record.
